(19) United States
(12) Patent Application Publication
(10) Pub. No.: US 2025/0073796 A1
(43) Pub. Date: Mar. 6, 2025

(54) THREAD MILLING TOOL AND METHOD FOR MACHINING THREADS

(71) Applicant: ISCAR, LTD., TEFEN (IL)

(72) Inventors: VITALY OREN, KFAR VRADIM (IL); YOSEF COHEN, NAHARIYA (IL); SERGEY IRLIN, KFAR VRADIM (IL); DMITRI KOROL, CARMIEL (IL)

(73) Assignee: ISCAR, LTD., TEFEN (IL)

(21) Appl. No.: 18/460,724

(22) Filed: Sep. 5, 2023

(51) Int. Cl. B23G 5/18; B23G 1/32

(52) U.S. Cl. CPC B23G 5/18; B23G 1/32; B23G 2200/12

(57) ABSTRACT

A thread milling cutter (1) includes an integrally formed thread milling tool (10) having a rotational axis (S), a shank portion (24) and a forward cutting portion (34). The cutting portion (34) has at least five insert pockets (42) recessed therein with at least one insert pocket (42) being devoid of an associated support protrusion (46), allowing different insert placements for different thread pitches.

### FIELD OF THE INVENTION

The subject matter of the present application relates to a thread milling tool (hereinafter also “tool”) used in metal threading machining. The subject matter of the present application further relates to a method of using a thread milling cutter (i.e. the thread milling tool together with cutting inserts mounted thereon) to machine threads.

### BACKGROUND OF THE INVENTION

Thread milling cutters are designed to provide external or internal threads on a typically metal workpiece. The present application is only directed to thread milling tools designed for releasably-mounted cutting inserts (hereinafter also “thread-cutting insert” and “insert”) and not directed to integral-teeth cutters.

Typically the workpiece or, alternatively, the cutter is rotated.

Typically, each active tooth (i.e. a tooth in use during a machining operation) of a cutting insert is supported by a projecting portion of the tool which provides additional stability, e.g. see US 2017/0129029. Stability during thread machining operations is of great importance because a small deviation can result in the thread not fulfilling a standard requirement.

To explain some of the terminology used hereinafter the term “axially adjacent” cutting edges means the two closest edges along an axis (regardless of their circumferential position along the tool). For example, at the bottom of FIG. 1 of US 2017/0129029 there is an insert shown at the bottom-right corner. The insert directly to the left thereof is the “axially adjacent” insert because the axial spacing is zero. By contrast the insert directly above is axially spaced apart therefrom at a certain distance and therefore it is not considered axially adjacent. Another example is shown in FIG. 1 of CN213410689 where an exemplary pair of axially adjacent edges (211, 212) are not at the same axial location but rather are axially spaced apart at some distance. However, since there is no cutting edges at an axial distance of zero, these edges (211, 212) are considered axially adjacent.

Typically, cutters have axially adjacent pairs of cutting edges where the axial spacing is zero, as exemplified in US 2017/0129029, because this is advantageous in that it allows more material removal as there is less forces on the cutting edges on a single axial location.

However, one example of a thread milling cutter with each axially adjacent pair of cutting edges being axially spaced apart from one another is disclosed in CN213410689. Notably, this is an integral-teeth cutter, which are known to be more structurally stable and precise than tools with cutting inserts.

CN105537700 discloses a non-integral tool having three modular body portions which allow radial adjustment. Each body portion has a single threading cutting insert at the front end thereof. Each thread-cutting insert has an active cutting tooth devoid of a support protrusion and axially spaced apart. The non-integral modular body portions allow the active cutting teeth to machine at different radii.

It is an object of the subject matter of the present application to provide an improved tool and cutter for versatility, stability and precision to those known, as well as a method providing these advantages.

### SUMMARY OF THE INVENTION

In accordance with a first aspect of the subject matter of the present application there is provided a thread milling tool being rotatable in a rotation direction about a rotational axis defining opposing inward and outward radial directions and opposing forward and rearward directions, the thread milling tool comprising:
a shank portion; and
a cutting portion located forwardly of the shank portion, the cutting portion comprising:
a cylindrical-shaped cutting peripheral surface; and
a plurality of insert pockets recessed into the cutting peripheral surface;
wherein:
the plurality of insert pockets are at least five insert pockets;
the thread milling tool is an integrally formed tool; and
at least one insert pocket, which is not a forward insert pocket, is devoid of an associated support protrusion.

The present invention facilitates a new method of thread machining, by allowing a user to select different cutting insert arrangements on a single integral tool which allows the same tool to be used for different thread pitches.

This is enabled by at least one insert pocket being devoid of a protrusion, which allows the cutting insert to be removed without the protrusion contacting the workpiece. Even though this theoretically is less stable than a design providing a cutting insert with a support protrusion it has been found that such a tool provides adequate stability.

As explained further below, there must be a minimal number of insert pockets to provide a reasonable number of possible insert placements.

The integral tool is believed to be more stable than a modular tool design as described above in CN105537700. Even though a thread milling cutter with cutting inserts is less stable than an integral-teeth cutter.

In accordance with a second aspect of the subject matter of the present application there is provided a method of machining a thread having a particular one of a predetermined number of different thread pitches using a single thread milling cutter, the method comprising: (a) providing a thread milling tool; (b) selecting a desired pitch length DPT of the thread to be machined; (c) determining a smallest non-zero integer K such that K*LPT/DPT results in an integer; (d) placing thread-cutting inserts in insert pockets so that the following condition: LPI=K*LPT is achieved between axially adjacent thread-cutting inserts placed in the thread milling tool; and (d) machining a workpiece in a movement at the desired pitch length DPT of the thread being machined.

In accordance with a third aspect of the subject matter of the present application there is provided a method of machining different pitched threads using a thread milling cutter having a rotation axis and a plurality of insert pockets arranged along an imaginary helix, wherein the thread-cutting inserts are secured to only a subset of the plurality of insert pockets and not all of the insert pockets.

It is understood that the above-said is a summary, and that features described hereinafter may be applicable in any combination to the subject matter of the present application, for example, any of the following features may be applicable to the thread-cutting insert and/or the thread milling cutter and/or the thread milling tool.

All of the insert pockets may be axially spaced apart from one another along the rotational axis.

A diameter Dm of the cutting portion may fulfill the following condition: Dm≤50 mm.

The plurality of insert pockets may be evenly distributed about and define an imaginary helix centered about the rotational axis.

Axially adjacent insert pockets may be not rotationally adjacent to one another and the imaginary helix may circle the rotational axis at least twice.

A lap sum SL, defined as the number of times the imaginary helix circles the rotational axis, and a pocket sum SP, defined as the number of insert pockets of the thread milling tool, may fulfil the following condition: SP/SL does not result in an integer.

A majority of the insert pockets may be devoid of an associated support protrusion.

Only the forward insert pocket may have an associated support protrusion.

There may be at most seventeen axially spaced apart insert pockets.

Each pair of rotationally adjacent insert pockets may be, at least partially, rotationally spaced apart from one another in the rotation direction.

At least one insert pocket may be surrounded by the cutting peripheral surface.

Each of the plurality of insert pockets may comprise: opposing rear and front pocket surfaces with a back pocket surface extending therebetween, the rear and front pocket surfaces being transverse to the rotational axis; a bottom pocket surface transverse to the rotation direction and extending between the rear, front and back pocket surfaces; and an internal front pocket angle apf, defined between the front pocket surface and a first imaginary plane perpendicular to the rotational axis, and an internal rear pocket angle apr, defined between the rear pocket surface and the first imaginary plane, may fulfil the following condition: apf<apr.

Each of the plurality of insert pockets may comprise: opposing rear and front pocket surfaces with a back pocket surface extending therebetween, the rear and front pocket surfaces being transverse to the rotational axis; a bottom pocket surface transverse to the rotation direction and extending between the rear, front and back pocket surfaces; and an insert seat recessed into the bottom pocket surface, the insert seat comprising: an insert seat floor transverse to the rotation direction; a rearward insert seat surface transverse to the rotational axis; a forward insert seat surface located forwardly of the rearward insert seat surface; and a reinforcement rib extending in the rotation direction from the insert seat floor to a top rib surface, extending in the forward direction from the rearward insert seat surface to a forward rib surface and delimited in the outward radial direction and a direction opposite thereto, respectively, by first and second rib side surfaces

A rib height Lr1, defined as perpendicular to the insert seat floor and measurable from the insert seat floor to the top rib surface, may fulfil the following condition: 0.4 mm≤Lr1≤1 mm; a rib width Lr2, defined as perpendicular to the rearward insert seat surface and measurable from the rearward insert seat surface to the forward rib surface, may fulfil the following condition: 0.2 mm≤Lr2≤1 mm; and a rib length Lr3, defined as parallel to a first intersection of the rearward insert seat surface with the insert seat floor and measurable from the first rib side surface to the second rib side surface, may fulfil the following condition: 1 mm≤Lr3≤5 mm.

A thread milling cutter may comprise the thread milling tool mentioned above and a plurality of thread-cutting inserts releasably secured thereto, each thread-cutting insert comprising: opposing top and bottom insert surfaces; a peripheral insert surface connecting the top and bottom insert surfaces; and a protruding cutting tooth formed with a protruding cutting edge located at an intersection of the top insert surface and the peripheral insert surface, the protruding cutting tooth protruding in the outward radial direction from the respective insert pocket; each insert pocket of the thread milling tool has an insert seat center; and all axially adjacent insert pockets which are located at different axial locations are axially spaced apart from one another by a tool pitch length measured parallel to the rotational axis, from the insert seat center of one of said insert pockets to an axially adjacent one of said insert pockets; wherein: all axially adjacent thread-cutting inserts which are located at different axial locations are distanced by an insert pitch length, defined as the axial distance along the rotational axis between the protruding cutting edges belonging to said each pair of axially adjacent thread-cutting inserts; and at least one of the protruding cutting teeth is devoid of an associated support protrusion.

Each thread-cutting insert may comprise: opposing top and bottom insert surfaces, with a peripheral insert surface extending therebetween, the peripheral insert surface comprising: a first insert side surface; a second insert side surface; and a third insert side surface located between the first and second insert side surfaces; wherein each of the plurality of insert pockets comprises: opposing rear and front pocket surfaces with a back pocket surface extending therebetween, the rear and front pocket surfaces being transverse to the rotational axis; a bottom pocket surface transverse to the rotation direction and extending between the rear, front and back pocket surfaces; and an insert seat recessed into the bottom pocket surface, the insert seat comprising: an insert seat floor transverse to the rotation direction; a rearward insert seat surface transverse to the rotational axis; a forward insert seat surface located forwardly of the rearward insert seat surface; and a reinforcement rib extending in the rotation direction from the insert seat floor to a top rib surface, extending in the forward direction from the rearward insert seat surface to a forward rib surface and delimited in the outward radial direction and a direction opposite thereto, respectively, by first and second rib side surfaces; wherein: first, second and third depressions are recessed at the intersection between the bottom insert surface and, respectively, the first, second and third insert side surfaces; the first, second and third depressions are delimited, respectively, by first, second and third top depression surfaces, first, second and third back depression surfaces and a first, second and third pair of opposing side depression surfaces; and each of the first, second and third depressions has the following dimensions: a depression length Ld1, parallel to a second intersection of the bottom insert surface and the respective surface of the first, second and third insert side surfaces and measurable from one of the surfaces of one of the first, second and third pair of opposing side depression surfaces to the other surface of the same pair of the first, second and third pair of opposing side depression surfaces, fulfilling the following condition: 3 mm≤Ld1≤10 mm; a depression height Ld2, perpendicular to the top and bottom insert surfaces and measurable from the bottom insert surface to the respective one of the first, second and third top depression surface, fulfilling the following condition: 0.8 mm≤Ld2≤1.2 mm; and a depression width Ld3, perpendicular to both the depression length and the depression height, and measured from one of the first, second and third insert side surfaces to the respective one of the first, second and third back depression surfaces, fulfilling the following condition: 0.6 mm≤Ld3≤1.4 mm.

The thread-cutting inserts may be releasably secured to a subset of the insert pockets such that at least some of the insert pockets, which are located at different axial locations, are unoccupied, with a number N of unoccupied insert pockets, which are located at different axial locations, being located between each axially adjacent pair of thread-cutting inserts, which are located at different axial locations, being the same.

There may be a constant number N of unoccupied insert pockets, each at different axial locations, which are located between each axially adjacent pair of thread-cutting inserts, which are located at different axial locations.

Our aim is to provide an integrally formed thread milling tool with improved rigidity which allows for a greater variability in the amount of thread pitches which can be machined by selective insert placement relative to the known thread milling cutters. It is also an object of the subject matter of the present application to provide a method allowing the machining of threads having different pitches in greater variability than traditionally available. Such a thread milling tool is especially advantageous for small diameter tools, specifically thread milling tools having a diameter of less than 50 mm.

### BRIEF DESCRIPTION OF THE FIGURES

For a better understanding of the present application and to show how the same may be carried out in practice, reference will now be made to the accompanying drawings, in which:

FIG. 1 is a perspective view of a thread milling cutter according to a first aspect of the present application;

FIG. 2 is a perspective view of the thread milling tool shown in FIG. 1;

FIG. 3 is a side view of the thread milling tool shown in FIG. 1;

FIG. 4 is a detailed view of the insert pocket shown in FIG. 3;

FIG. 5 is a cross-section view along line A-A, perpendicular to the rotational axis, shown in FIG. 4;

FIG. 6a is a first perspective view, facing in the rearward direction, of the insert pocket shown in FIG. 4;

FIG. 6b is a second perspective view, facing in the forward direction, of the insert pocket shown in FIG. 6a;

FIG. 7a is a perspective view of the thread-cutting insert shown in FIG. 1;

FIG. 7b is a top view of the thread-cutting insert shown in FIG. 7a;

FIG. 7c is a side view of the thread-cutting insert shown in FIG. 7a;

FIG. 7d is a bottom view of the thread-cutting insert shown in FIG. 7a;

FIG. 8 is a side view of the thread milling cutter shown in FIG. 1;

FIG. 9 is a side view of the thread milling cutter shown in FIG. 8, having less thread-cutting inserts secured thereto;

FIG. 10 is a perspective view of the thread milling cutter shown in FIG. 9, having less thread-cutting inserts secured thereto;

FIG. 11 is a detailed view of the thread-cutting insert secured in the insert pocket shown in FIG. 8;

FIG. 12a is a cross-section view along line B-B shown in FIG. 8;

FIG. 12b is a detailed view of the reinforcement rib and first depression shown in FIG. 12a;

FIG. 13a is a cross-section view along line C-C shown in FIG. 8;

FIG. 13b is a detailed view of the groove and third depression shown in FIG. 13a;

FIG. 14 is a perspective view of the thread milling cutter shown in FIG. 1 having a support protrusion;

FIG. 15 is a perspective view of the thread milling tool shown in FIG. 14; and

FIG. 16 is a front end view of the thread milling cutter shown in FIG. 1.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

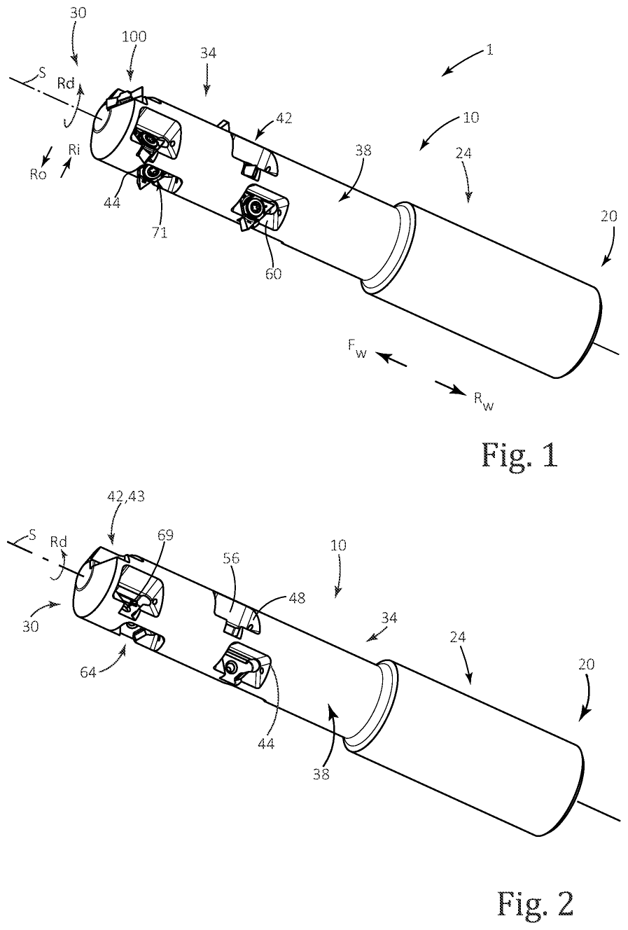

Attention is first drawn to FIGS. 1, showing a thread milling cutter 1 according to the present application. The thread milling cutter 1 includes a thread milling tool 10 and a plurality of thread-cutting inserts 100 releasably secured thereto. Typically, the thread-cutting inserts 100 are made of harder material than the thread milling tool 10, such as cemented carbide, for example.

As seen in FIGS. 2 to 6b, the thread milling tool 10 is rotatable in a rotation direction Rd about a rotational axis S. The rotational axis S defines opposing inward and outward radial directions Ri, Ro, which are perpendicular to the rotational axis S. The inward radial direction Ri is directed towards the rotational axis S, while the outward radial direction Ro is directed away from the rotational axis S.

The rotational axis S further defines opposing forward and rearward directions Fw, Rw. The forward direction Fw is parallel to the rotational axis S and the rearward direction Rw is opposite (i.e. directed at 180°) thereto.

The thread milling tool 10 is integrally formed (i.e. all elements of the thread milling tool 10 are permanently fixed to one another, for example in a one-piece construction or brazed to one another) and includes a shank portion 24 and a cutting portion 34. The cutting portion 34 is located forwardly of the shank portion 24. The thread milling tool 10 is delimited in the rearward direction Rw by a rearward end portion 20. The shank portion 24 may include the rearward end portion 20. The thread milling tool 10 is delimited in the forward direction Fw by a forward end portion 30. The cutting portion 34 may include the forward end portion 30. Shank portions of such thread milling tools are typically releasably secured to turrets for metal machining thread-milling operations. In some exemplary embodiments, the rotational axis S may also pass through the center of the shank portion 24 (i.e. the rotational axis S coincides with a center axis of the thread milling tool 10). Preferably but optionally, the shank portion 24 connects to the cutting portion 34.

The cutting portion 34 includes a cylindrical-shaped cutting peripheral surface 38 and a plurality of insert pockets 42. The cutting peripheral surface 38 extends, and is centered, about the rotational axis S. Each insert pocket 42 of the plurality of insert pockets 42 is recessed in the cutting peripheral surface 38. An insert pocket peripheral edge 44 may be defined at the intersection of each insert pocket 42 and the cutting peripheral surface 38.

Preferably but optionally, at least some of the insert pockets 42 are not continuous with one another. That is to say, at least one insert pocket 42 is surrounded (i.e. circumscribed) by the cutting peripheral surface 38. Preferably, a plurality of the insert pockets 42 may be surrounded by the cutting peripheral surface 38. More preferably, a majority of all insert pockets 42 may be surrounded by the cutting peripheral surface 38. Differently put, the insert pocket peripheral edge 44 circumscribes only its respective insert pocket 42 (in contrast with flutes—not shown but feasible together with other inventive aspects of the invention). This may create a more rigid and robust thread milling tool 10.

In other words, at least one of the insert pockets 42, and preferably but optionally all insert pockets 42, are not connected to one another. This does not necessarily include insert pockets 42 located at extremities of the cutting portion 34 along the rotational axis S (i.e. in one of the forward and rearward directions Fw, Rw) which may also open out to surfaces other than the cutting peripheral surface 38. The thread milling tool 10 is thus made sturdier, due to an increased tool thickness (relative to an embodiment including a flute—i.e. all insert pockets 42 are connected to one another via a groove sunk into the cutting peripheral surface 38) with less deflections, relative to cutting tools having flutes (not shown).

There are at least five insert pockets 42 included in the cutting portion 34. Preferably but optionally, there may be at least nine insert pockets 42 included in the cutting portion 34. To allow more versatility in machining different thread pitches using the same thread milling tool 10 and selective placement of the thread-cutting inserts 100 (i.e. releasably securing thread-cutting inserts 100 to only a subset of the insert pockets 42), having more insert pockets 42 is advantageous, as will be explained below.

Having only a subset of the insert pockets 42 occupied may cause an imbalance in the distribution of the thread-cutting inserts 100 about the thread milling cutter 1. That is to say, only when all insert pockets 42 are occupied it can be guaranteed that all thread-cutting inserts are equally distributed about the rotational axis S. However, despite said imbalance, the versatility in machining threads possible due to selective insert placement is highly desirable.

It will be understood that if, for example, the tool according to the present invention had five insert pockets it would allow five different insert placements, with four different possible numbers of thread-cutting inserts (5 inserts, 3 inserts, 2 inserts and one insert) resulting in different possible pitches (which will be discussed below). Similarly, in this more advantageous embodiment with nine insert pockets there are nine different possible insert placements, with five different possible numbers of thread-cutting inserts (9 inserts, 5 inserts, 3 inserts, 2 inserts and one insert). It will therefore be understood that a relatively larger number of pockets achieves a greater versatility advantage. Note that using only one insert during machining operations means that the productivity of the machining operation is highly impacted relative to operations using a plurality of inserts. Thus it is desirable to be able to use at least two inserts during machining operations.

However, due to the precision needed for thread milling tools, each additional pocket bears a risk during production of being inaccurately produced thereby rendering the entire integrally formed tool unusable. Additionally, more insert pockets 42 means that the thread milling tool 10 will be elongated to accommodate the insert pockets 42. Long thread milling tools may be more susceptible to deflection during machining operations, which may lower the surface quality of the threads being machined. Therefore, there is an advantageous upper limit for the number of pockets. As such, preferably but optionally, there are no more than seventeen insert pockets 42 included in the cutting portion 34. Preferably, there are no more than 13 insert pockets 42 included in the cutting portion 34.

In this embodiment, each insert pocket 42 is axially spaced apart (i.e. distanced in a direction along the rotational axis S) relative to the rest of the insert pockets 42. In other words, every pair of axially adjacent insert pockets 42 does not have a complete overlap in a direction along the rotational axis S. To explain, no two insert pockets 42 occupy the same axial location (i.e. a location on a plane perpendicular to the rotational axis S)—at least a portion of each insert pocket 42 does not overlap along the rotational axis S with another insert pocket 42. Differently said, each of the plurality of insert pockets 42 are consecutively arranged along the rotational axis S.

The advantage of this is that the tool body is structurally stronger (less material removed at each axial location). This is done to lessen the vibrations arising during thread milling operations by decreasing the number of operational cutting edges at each axial location to one, while at the same time the thread milling tool 10 has less deflection relative to thread milling tools having multiple insert pockets occupying the same axial location completely. To elaborate, a tool having multiple insert pockets completely overlapping one another along the rotational axis makes the tool holder more pliant at the axial locations of such overlaps (relative to other axial locations of the same tool) due to the tool being thinner at said axial locations. Such pliability may cause the tool to be more inclined to deflections, vibrations and the like. Other benefits, for example, may be axially non-consecutive order of cutting, dense insert pocket placement (explained below) and a more even distribution of the thickness of the tool holder (relative to tool holders with multiple overlapping insert pockets).

The above described advantages of having each insert pocket 42 axially spaced apart relative to the other insert pockets 42 is especially desirable in thread milling tools having small diameters. Preferably but optionally, a diameter Dm of the cutting portion 34 of the thread milling tool 10, as seen in FIG. 16, fulfils the following condition: Dm≤50 mm. Preferably, the diameter Dm fulfils the following condition: Dm≤43 mm. More preferably, the diameter Dm fulfils the following condition: Dm≤30 mm. For thread milling tools with small diameters, the tool is prone to deflection among other issues. Thus it is desirable to reinforce the rigidity of the tool, which is the main advantage of the above-mentioned embodiment.

Of course, in applications where the lessening of structural strength is acceptable, it is possible to provide a tool with more than one insert pocket per axial location.

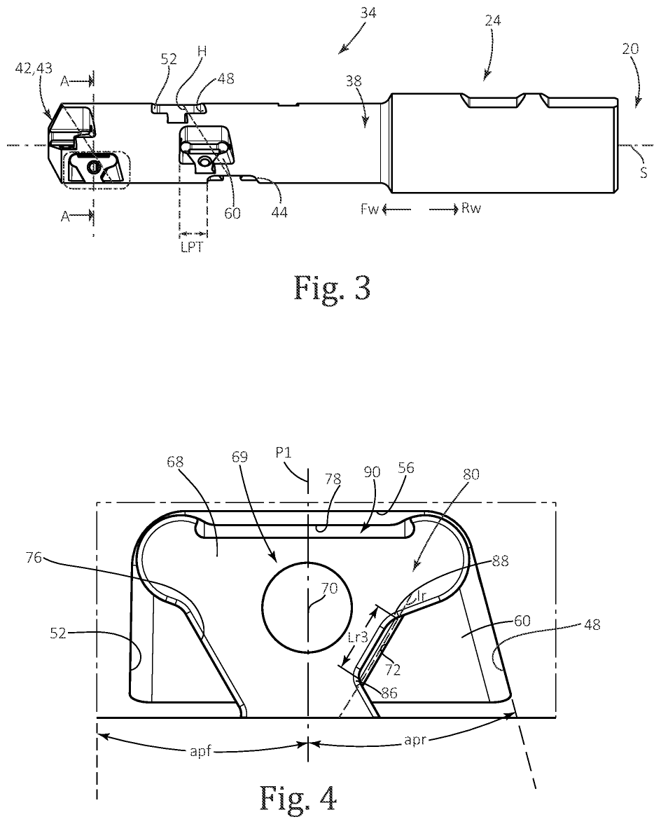

Dense insert pocket placement (i.e. an axial distance between axially adjacent insert pockets 42 being shorter than typical) means that the distance between two axially adjacent insert pockets is smaller than what would be possible in thread milling tools having a plurality of insert pockets located at the same axial location. For example, it can be seen in FIG. 3 that the two insert pockets 42 located farthest to the left in the figure overlap one another in a direction along the rotational axis S. Such an overlap is not possible in thread milling tools having a plurality of insert pockets located at the same axial location, because such an axial overlap would also cause a radial overlap between the insert pockets in a direction of rotation of the thread milling tool (i.e. the insert pockets would breach one another), compromising the abutment of the thread-cutting inserts to the insert pockets, the rigidity of the insert pockets as well as the rigidity of the thread milling tool.

To ensure that selective insert placement in the thread milling tool 10 is possible, at least one insert pocket 42, excluding a forward insert pocket 43 (which will be discussed below), is devoid of an associated support protrusion 46 (i.e. a support protrusion 46 which would support the thread-cutting insert 100 fastened to the insert pocket 42). That means at least one axial location which includes an insert pocket 42 does not include a support protrusion 46. Support protrusions 46 extend beyond an imaginary cylinder IC coinciding with the cutting peripheral surface 38. Thus, the support protrusions 46 provide their associated thread-cutting insert 100 with support closer to its active cutting edge (i.e. the cutting edge engaging the workpiece—referred to as protruding cutting edge 116a below) during machining. In other words, at the axial location of at least one insert pocket 42, the thread milling tool 10 does not extend beyond the imaginary cylinder IC coinciding with the cutting peripheral surface 38.

In such cases, at least one of the insert pocket peripheral edges 44 does not extend beyond the imaginary cylinder IC coinciding with the cutting peripheral surface 38. The support protrusion 46 enforces the thread-cutting insert 100 seated in the insert pocket 42 with support closer to its working portion (i.e. a protruding cutting edge 116a, which will be discussed below). During machining such a support protrusion would hamper the operation when the associated insert pocket 42 is unoccupied (i.e. without a thread-cutting insert 100 seated in the associated insert pocket 42).

Preferably but optionally, at least two insert pockets 42 (non-consecutive along the rotational axis S), may be devoid of associated support protrusions 46. Preferably, a majority of all insert pockets 42 are devoid of associated support protrusions 46. More preferably, all insert pockets 42, not including the forward insert pocket 43, may be devoid of associated support protrusions. Most preferably, all insert pockets 42 (including the forward insert pocket 43) may be devoid of associated support protrusions 46. In such case, the whole cutting portion 34 of the thread milling tool 10 may be delimited by the imaginary cylinder IC coinciding with the cutting peripheral surface 38.

Differently worded, preferably but optionally, a plurality of axial locations, each of which includes at least one insert pocket 42, do not include support protrusions 46. In other words, at the axial locations of a plurality of insert pockets 42, the thread milling tool 10 does not extend beyond the imaginary cylinder IC coinciding with the cutting peripheral surface 38. In such cases, a plurality of insert pocket peripheral edges 44 do not extend beyond the imaginary cylinder IC coinciding with the cutting peripheral surface 38. Preferably, all insert pocket peripheral edges 44 may not extend beyond the imaginary cylinder IC coinciding with the cutting peripheral surface 38. Preferably but optionally, all insert pocket peripheral edges 44 coincide with the imaginary cylinder IC coinciding with the cutting peripheral surface 38.

Insert pockets 42 that are devoid of associated support protrusions 46 are insert pockets 42 that can be left unoccupied during machining operations. Thus, more insert pockets 42 being devoid of associated support protrusions 46 means increasing the options in choosing the insert placements in the thread milling tool 10. At the same time, supplying support protrusions associated with insert pockets 42 which are sure to be occupied in all (or at least most) insert placements is advantageous as well. Thus, depending on specific needs the number of support protrusions 46 may change from one thread milling tool to another, from no support protrusions to a majority of the insert pockets having associated support protrusions.

In some embodiments, each insert pocket 42 is rotationally distanced (i.e. distanced in a direction of the rotation direction Rd) relative to the rest of the insert pockets 42. That is to say, every pair of insert pockets 42 is at least partially rotationally spaced apart from one another in the rotation direction Rd (As shown in a front end view of the thread milling cutter 1 in FIG. 16). Worded differently, no two insert pockets 42 have an exact rotational overlap (i.e. no complete overlap) in the rotation direction Rd (i.e., the circumferential direction). Having the insert pockets 42 rotationally distanced from one another ensures that, during thread milling operations, the thread-cutting inserts 100 engages the workpiece sequentially (i.e., in succession), rather than simultaneously. This can lower the cutting forces during machining operations, which generally improves the surface quality of the thread by reducing deflection, vibrations and the like.

Each of the plurality of insert pockets 42 further includes opposing rear and front pocket surfaces 48, 52, with a back pocket surface 56 extending therebetween. Preferably but optionally, the rear and front pocket surfaces 48, 52 are transverse to the rotational axis. Preferably, the rear pocket surface 48 may be facing in the forward direction Fw and the front pocket surface 52 may be facing in the rearward direction Rw.

A bottom pocket surface 60 extends between the rear, front and back pocket surfaces 48, 52, 56. The bottom pocket surface 60 is, preferably but optionally, transverse to the rotation direction Rd. The bottom pocket surface 60 may also face in the rotation direction Rd.

In some embodiments, each of the plurality of insert pockets 42 further includes an insert seat 64 recessed into the bottom pocket surface 60. The insert seat 64 includes an insert seat floor 68, a rearward insert seat surface 72, a forward insert seat surface 76 a back insert seat surface 78 and a reinforcement rib 80. In such embodiments the thread-cutting inserts 100 are seated in the insert seat 64. Alternatively, for example, the thread-cutting inserts 100 may each be seated in a respective insert pocket 42.

Preferably but optionally, all insert pockets 42 and their respective insert seats 64 are stationary (i.e. immovable) relative to one another. Further, it is preferable but optional that all insert pockets 42 and insert seats 64 are stationary relative to the thread milling tool 10.

The insert seat floor 68 is, preferably but optionally, transverse to the rotation direction Rd and may further be perpendicular thereto. The rearward insert seat surface 72 extends from the insert seat floor 68 and is, preferably but optionally, transverse to the rotational axis S. The forward insert seat surface 76 extends from the insert seat floor 68, is located axially forward of the rearward insert seat surface 72 and is, preferably but optionally, transverse to the rotational axis S. The rearward insert seat surface 72 is, preferably but optionally, facing in the forward direction Fw. The forward insert seat surface 76 is preferably but optionally facing in the rearward direction Rw. The back insert seat surface 78 connects the insert seat floor 68 and the rearward and forward insert seat surfaces 72, 76.

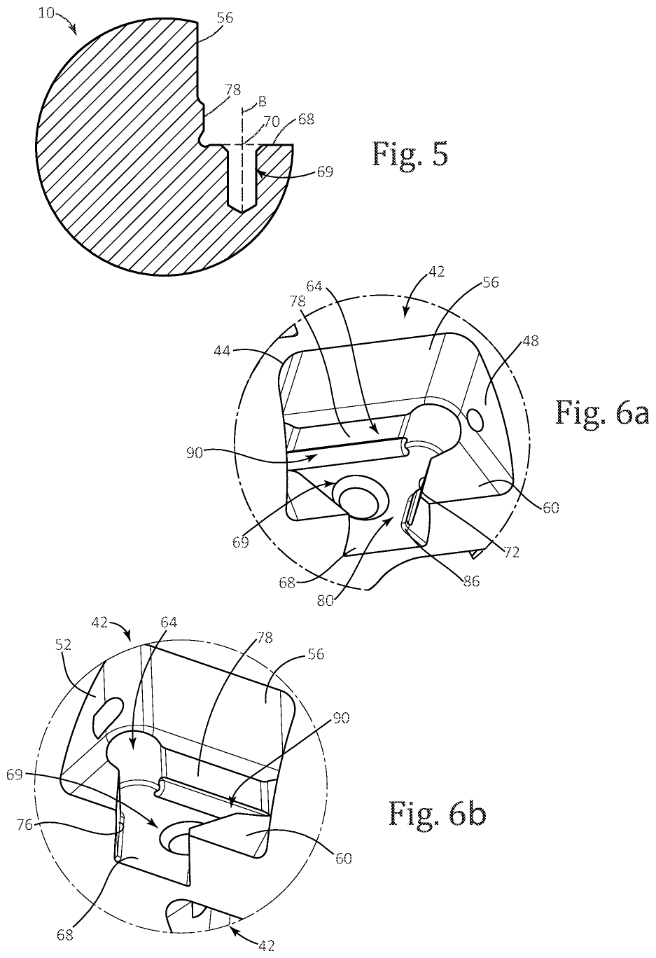

In some embodiments, as shown in FIG. 5, in a view along a line A-A, seen in FIG. 3, which is perpendicular to the rotational axis S, the insert pocket 42 includes a securing bore 69 and an insert seat center 70. The securing bore 69 is threaded, may open out to the insert seat floor 68 and has a bore center axis B. This is to allow a clamping means, such as a screw 71, to clamp a thread-cutting insert to the insert pocket 42, and more specifically to the insert seat floor 68. The insert seat center 70 is defined, for example for a radial-type insert, as the intersection of the bore center axis B and the insert seat floor 68. When referring to a location of the insert pockets 42 it may be understood to, more specifically, be referring to the insert seat center 70.

In some embodiments, it may be beneficial to have the forward and rearward insert seat surfaces 72, 76 converge towards one another. Such convergence may serve to strengthen the thread milling cutter 1 by reducing the size of the insert pockets 42. In many cases, thread-cutting inserts 100 seated in an insert seat 64 only abut one of the rearward and forward insert seat surfaces 72, 76 (along with the insert seat floor 68). Thus having both the forward and rearward insert seat surfaces 72, 76 converging towards one another is not necessary but may be advantageous.

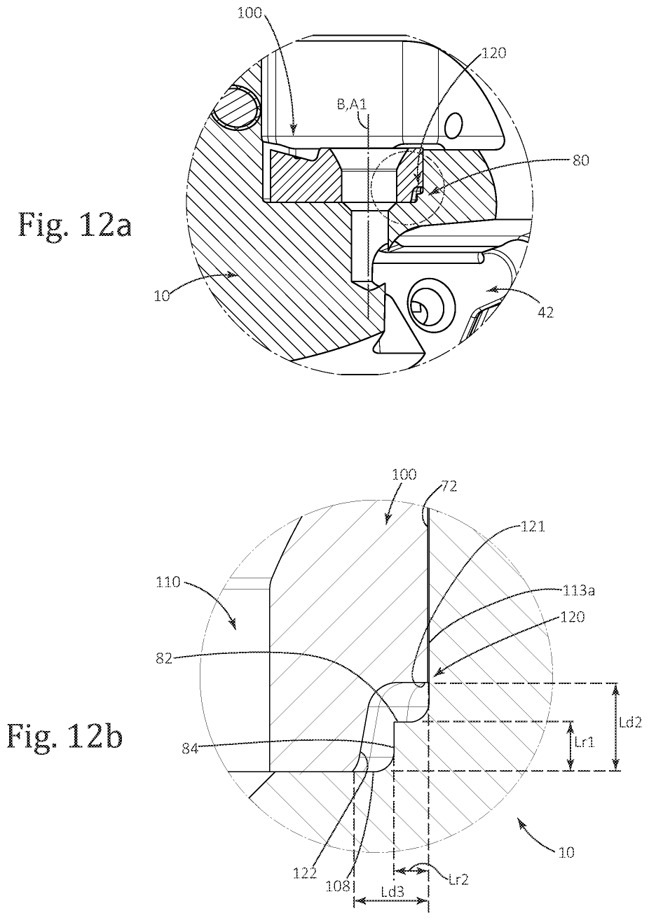

In some embodiments, the reinforcement rib 80 extends in the rotation direction Rd from the insert seat floor 68 to a top rib surface 82 (see FIG. 12b). The top rib surface 82 delimits the reinforcement rib 80 in the rotation direction Rd. The reinforcement rib 80 also extends in the forward direction Fw from the rearward insert seat surface 72 to a forward rib surface 84. The forward rib surface 84 delimits the reinforcement rib 80 in the forward direction Fw. The reinforcement rib 80 is also delimited in the outward radial direction Ro and a direction opposite thereto, respectively, by first and second rib side surfaces 86, 88. The reinforcement rib 80 may optionally extend along the entire length of the rearward insert seat surface 72. Alternatively, the reinforcement rib 80 may span only a portion of the length of the rearward insert seat surface 72.

In some cases, such as shown in FIGS. 6a, 6b, 9 and 12a, the axial overlap between two axially adjacent insert pockets 42 which are located at different axial locations (i.e. axially spaced apart as discussed above) may leave a portion of some of the insert pockets 42 thin (specifically a portion between the insert seat floor 68 of one of the insert pockets 42 and the back pocket surface 56 of a respective one of the insert pockets 42 adjacent thereto). In order to reinforce the insert pockets 42, the reinforcement rib 80 may be added to at least some of the insert pockets 42. This reinforces the above mentioned thin portion to have a greater thickness, which may strengthen the rigidity of the insert pockets 42 and the thread milling tool 10.

As best shown in FIGS. 4 and 12b, a rib height Lr1, defined as perpendicular to the insert seat floor 68 and measurable from the insert seat floor 68 to the top rib surface 82, may fulfil the following condition: 0.4 mm≤Lr1≤1 mm. Preferably, the rib height Lr1 may fulfil the following condition: 0.45 mm≤Lr1≤0.85 mm. Line B-B, along which the cross-section view in FIG. 12a is shown, is perpendicular to the rearward insert seat surface 72.

A rib width Lr2, defined as perpendicular to the rearward insert seat surface 72 and measurable from the rearward insert seat surface 72 to the forward rib surface 84, may fulfil the following condition: 0.2 mm≤Lr2≤1 mm. Preferably, the rib width Lr2 may fulfil the following condition: 0.3 mm≤Lr2≤0.85 mm.

A rib length Lr3, defined as parallel to a first intersection Ir of the rearward insert seat surface 72 with the insert seat floor 68 and measurable from the first rib side surface 86 to the second rib side surface 88, may fulfill the following condition: 1 mm≤Lr3≤5 mm. Preferably, the rib length Lr3 may fulfil the following condition: 1.5 mm≤Lr3≤4 mm.

Adding the reinforcement rib 80 to at least one of the insert pockets 42 means that, while the insert pocket 42 is reinforced, the thread-cutting insert 100 placed within the insert pocket 42 must accommodate the reinforcement rib 80. This means that the overlap (i.e. abutment) between the thread-cutting insert 100 and the insert pocket 42 must be smaller than in embodiments without the reinforcement rib 80. Further, the thread-cutting insert 100 must have a portion sunk into it, which may increase production costs and may also decrease the insert stability. As such, the size of the reinforcement rib 80 must take into consideration the positive aspects of reinforcing the insert pockets 42 as well as the negative repercussions of potentially weakening the thread-cutting insert 100. The above ranges for the size of the reinforcement rib 80 were found to be a suitable balance between the negative and positive effects mentioned above.

It will be noted that the thread-cutting inserts 100 do not abut the reinforcement rib 80. Rather, the thread-cutting inserts 100 are spaced apart from the reinforcement rib 80, as shown in FIG. 12b, and evident when comparing the dimensions of the reinforcement rib 80 to those of the thread-cutting inserts 100. This is done to ensure there is no over-constraint abutment (i.e. too many surfaces theoretically making contact simultaneously, which requires very stringent tolerances) between the thread-cutting inserts 100 and the insert pockets 42.

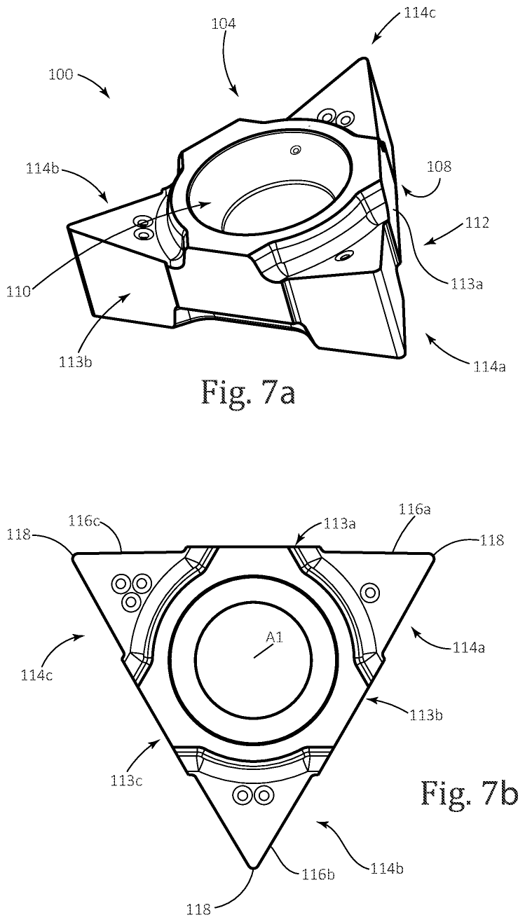

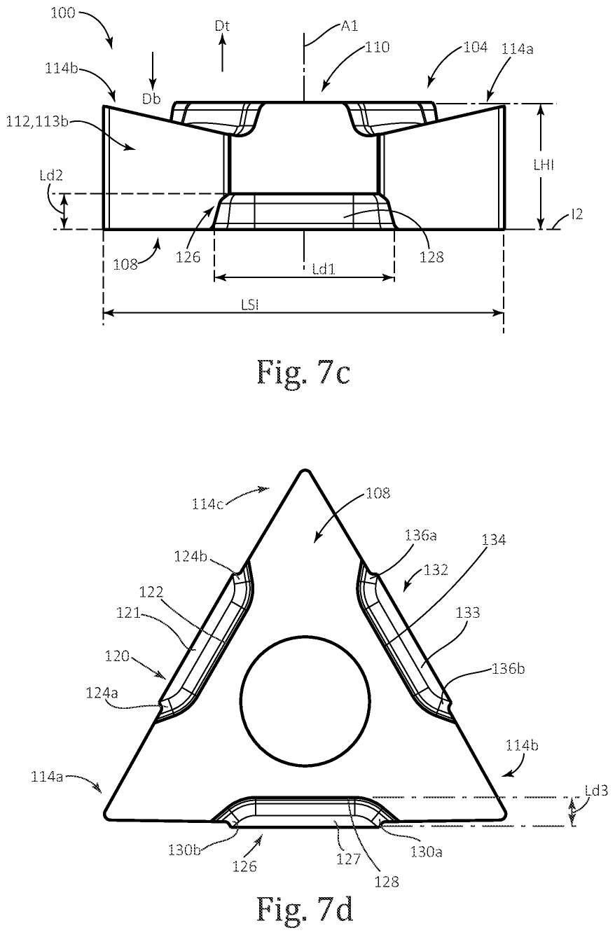

More specific dimensions of the reinforcement rib 80 are available for specific thread-cutting inserts 100 sizes. For instance, in embodiments where the thread-cutting inserts 100 have the shape of an equilateral triangle (as seen in FIG. 7b), have an insert side length LSI fulfilling the condition: 10 mm≤LSI≤12 mm and an insert height LHI fulfilling the condition: 2 mm≤LHI≤4 mm (both of which will be discussed below), the dimensions of the reinforcement rib 80, which are adjusted according to the thread-cutting insert 100, may fulfil the following conditions: 0.45 mm≤Lr1≤0.75 mm, 0.3 mm≤Lr2≤0.6 mm and 1.5 mm≤Lr3≤3.5 mm. Preferably, the insert side length LSI and insert height LHI may fulfil the following conditions: 10.5 mm≤LSI≤11.5 mm and 2.7 mm≤LHI≤3.5 mm.

Similarly, in embodiments where the thread-cutting inserts 100 have the shape of an equilateral triangle with the insert side length LSI and the insert height LHI fulfil the following conditions: 15 mm≤LSI≤17 mm and 2.5 mm≤LHI≤4.5 mm, the dimensions of the reinforcement rib 80 may fulfil the following conditions: 0.55 mm≤Lr1≤0.85 mm, 0.55 mm≤Lr2≤0.85 mm and 1.5 mm≤Lr3≤4 mm.

In some embodiments, a groove 90 may be recessed between the back insert seat surface 78 and the insert seat floor 68. Contrary to the addition of the reinforcement rib 80 to the insert pockets 42 to reinforce said insert pocket 42, the area between the back pocket surface 56 and the insert seat floor 68 is much thicker, and thus does not need to be reinforced. Instead, the groove 90 ensures that when the thread-cutting inserts 100 are clamped in the insert pockets 42 forces are more evenly dispersed and not concentrated about weak points of the thread-cutting inserts 100 (such as corners of the thread-cutting inserts 100).

In some embodiments, such as seen in FIG. 4, an internal front pocket angle apf is defined between the front pocket surface 52 and a first imaginary plane P1. The first imaginary plane P1 is perpendicular to the rotational axis S and passes through the respective insert pocket 42. Similarly, an internal rear pocket angle apr is defined between the rear pocket surface 48 and the first imaginary plane P1. The internal front pocket angle apf and the internal rear pocket angle apr are to be measured as internal angles, meaning measured from the respective surfaces to the first imaginary plane P1 within the bounds of the insert pocket 42.

In some embodiments, there may be structural weaknesses in insert pockets 42 which are caused by the proximity of other insert pockets 42. Such weaknesses may be, for example, caused by securing bores breaching into insert pocket 42, or a thin portion located between insert pockets 42, as discussed above. In the non-limiting example shown in FIGS. 6b and 9, securing bores 69 breach the front pocket surface 52 of an axially subsequent insert pocket 42. To improve the structural integrity of the insert pockets 42 in this specific configuration, the internal front pocket angle apf and the internal rear pocket angle apr may fulfil the following condition: apf<apr. This may also reinforce the thin portion discussed above. Alternatively, in some embodiments, the internal front pocket angle apf and the internal rear pocket angle apr may fulfil the following condition: apr<apf. For example, this may occur when securing bores 69 breach the rear pocket surface 48.

In some embodiments, the plurality of insert pockets 42 circle the rotational axis S at least twice. For example, drawing a line (not shown) connecting the insert pocket 42 located farthest in the forward direction Fw to its axially adjacent insert pocket 42 (i.e. closest the insert pocket 42 closest along the rotational axis S), and continuing in the rotation direction Rd to axially consecutive insert pockets 42 until reaching the insert pocket 42 located farthest in the rearward direction Rw, will result in the drawn line encircling the thread milling tool 10 and the rotational axis S at least twice. This is particularly beneficial when all insert pockets 42 are located at different axial locations relative to one another because it vastly increases the axial spacing between consecutively cutting active teeth.

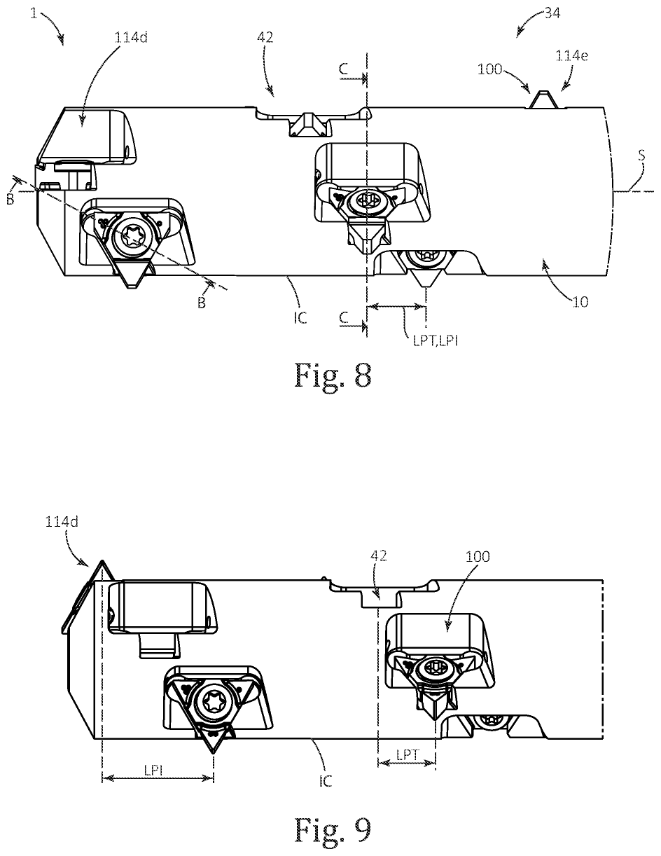

This allows the thread-cutting inserts 100 to engage the workpiece in an axially non-sequential (i.e. axially non-consecutive) order which may result in less deflection. Axially “non-sequential” (or “non-consecutive”) is to be understood as not following the order of placement along the rotational axis S. For example, during machining operations of the cutting tool seen in FIG. 8, the leftmost thread-cutting insert 100 (in this case, the one located farthest in the forward direction Fw) may engage the workpiece first. However, the thread-cutting insert 100 to engage the workpiece next is not the axially adjacent thread-cutting insert 100 (i.e. the one located second farthest in the forward direction Fw), but rather the thread-cutting insert 100 intersected by line C-C. This disperses the cutting forces arising during machining more evenly about the thread milling cutter 1 and may thus reduce deflection and the like.

However, having a non-sequential cutting order means that upon leaving at least one of the insert pockets 42 unoccupied, the thread-cutting inserts 100 may be distributed unevenly about the rotational axis S. This means that some of the thread-cutting inserts 100 will wear out faster than the others due to varying rotational distances between different pairs of rotationally adjacent thread-cutting inserts 100.

In some embodiments, as shown in FIG. 3, all insert pockets 42 are distributed evenly along, and define, an imaginary helix H. The imaginary helix H is centered about the rotational axis S and has a fixed helix angle (not shown). All insert pockets 42 being distributed evenly about the imaginary helix H means that any pair of axially adjacent insert pockets 42 are located on the imaginary helix H and are axially, and rotationally, distanced from one another at identical distances to any other pair of axially adjacent insert pockets 42.

In this manner, it is ensured that no insert pocket 42 has an exact overlap (i.e. without any portion that does not overlap), in a front end view of the thread milling tool 10, with one of the other insert pockets 42, as seen in FIG. 16. That is to say, any two insert pockets 42 will, at most, have a partial overlap (i.e. with at least a portion that does not overlap) with one another in both a front end view and a side view of the thread milling tool 10, as shown in FIGS. 16 and 3, respectively. It is preferable, but optional, for values of a lap sum SL (i.e. the number of times the insert pockets 42 circle the rotational axis S) fulfilling the following condition: SL>1, that the pocket sum SP (i.e. the number of insert pockets 42 of the thread milling tool 10) fulfils the following condition: SP/SL does not result in an integer. Otherwise an even distribution of the insert pockets 42 along the imaginary helix H may result in an exact overlap between radially adjacent insert pockets 42 which is undesirable. For example, in the embodiment shown, SL=2 (which is greater than 1) and SP=9. Thus SP/SL=4.5 and does not result in an integer.

In some embodiments, depending on the size of the thread-cutting inserts 100 and the diameter of the thread milling tool 10, the overlap in a front end view between any two insert pockets 42 may be at most 90% of the insert pockets 42. Preferably, the overlap in a front end view between any two insert pockets 42 may be at most 50% of the insert pockets 42. More preferably, the overlap in a front end view between any two insert pockets 42 may be at most 20% of the insert pockets 42. Some of these preferences may be unavailable in certain thread milling tools, such as, for example, milling tools with small diameters.

However, the present embodiment of the thread milling tool 10 with all insert pockets 42 which are located at different axial locations relative to one another, is especially advantageous for milling tools having small diameters, preferably for tools having diameters smaller than 50 mm, because the rigidity of the tool is increased.

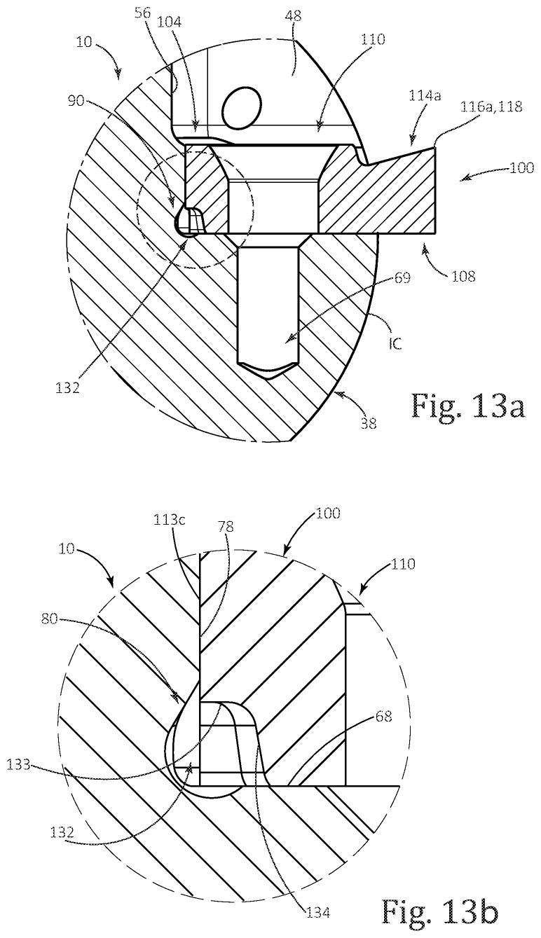

Now referring to FIGS. 7a to 13b, each thread-cutting insert 100 of the plurality of thread-cutting inserts 100 includes a top insert surface 104, a bottom insert surface 108, a peripheral insert surface 112 and a protruding cutting tooth 114a. The top and bottom insert surfaces 104, 108 oppose one another. Specifically, each thread-cutting insert 100 has a first insert axis A1 defining opposing top and bottom insert directions Db, Dt, and the opposing top and bottom insert surfaces 104, 108 may be defined as perpendicular to the first insert axis A1.

The top insert surface 104 is located in the top direction relative to the bottom insert surface 108. An insert bore 110 may open up to the top and bottom insert surfaces 104, 108. The first insert axis A1 may coincide with a center axis B of the insert bore 110. To clarify, thread-cutting means that a cutting insert is used for machining threads in workpieces, with a cutting tooth configured to machine grooves making up a thread.

The peripheral insert surface 112 connects the top and bottom insert surfaces 104, 108. The protruding cutting tooth 114a is formed with the protruding cutting edge 116a located at an intersection of the top insert surface 104 and the peripheral insert surface 112. When one of the thread-cutting inserts 100 is seated in the insert pocket 42, the protruding cutting tooth 114a protrudes in the outward radial direction Ro from the respective insert pocket 42. Differently stated, at least a portion of the protruding cutting tooth 114a is located farther in the outward radial direction Ro than its corresponding insert pocket peripheral edge 44.

When placing thread-cutting inserts 100 in the insert pockets 42 the bottom insert surface 108 abuts the insert seat floor 68 and a clamping means, such as the aforementioned screw 71, engages the securing bore 69 and releasably secures the thread-cutting insert 100 to the insert pocket 42.

In some embodiments, the thread-cutting insert 100 further includes additional cutting teeth. For example, as shown in FIG. 7b, each thread-cutting insert 100 of the plurality of thread-cutting inserts 100, in addition to the protruding cutting tooth 114a, may further include additional cutting teeth 114b, 114c. Differently stated, each cutting insert 100 may include first, second and third cutting teeth 114a, 114b, 114c, which are respectively referred to as “protruding cutting tooth 114a” and “additional cutting teeth 114b, 114c”. It is understood in this context that the “protruding cutting tooth” refers to a cutting tooth that protrudes from the cutting peripheral surface 38 and thus serves as an “operative” or “active” cutting tooth during threading operations.

The additional cutting teeth 114b, 114c are located within their respective insert pocket 42 without protruding in the outward radial direction Ro therefrom (i.e. non-protruding). Each of the additional cutting teeth 114b, 114c include an additional cutting edge 116b, 116c located at an intersection of the top insert surface 104 and peripheral insert surface 112.

It will be understood that the protruding cutting tooth 114a and any additional cutting teeth (such as the second and third cutting teeth 114b, 114c) are interchangeable and dependent on the placement of the thread-cutting insert in the insert pocket 42. In other words, the cutting insert seen in FIG. 7a, 7c may be indexed so that each of its cutting teeth 114a, 114b, 114c may, in turn, serve as the protruding cutting tooth. Also, when referring to the thread-cutting inserts 100 separate of the thread milling tool 10 the cutting teeth 114a, 114b, 114c will be arbitrarily assigned the above mentioned names “first, second and third” cutting teeth 114a, 114b, 114c.

A tool pitch length LPT is defined in the thread milling tool 10 as parallel to the rotational axis S, and measured from the insert seat center 70, of one insert pocket 42 to an insert seat center 70 of an axially adjacent insert pocket 42 which is located at a non-zero axial distance (i.e. at different axial locations) from aforementioned insert pocket 42. It will be noted that the measurement of the tool pitch length LPT may be done between any two points located similarly in two axially adjacent insert pockets 42. The insert seat center 70 has been specified and chosen as an example.

In the preferred embodiment shown, each insert pocket 42 is axially spaced apart from the other insert pockets 42. An insert pocket 42 may have exactly one axially adjacent insert pocket 42 (for example each of the extremity insert pockets shown—the forwardmost or rearwardmost insert pockets), and may alternatively have exactly two axially adjacent insert pockets 42 (for example each of the insert pockets except for the extremity insert pockets), one in the forward direction Fw thereof and the other in the rearward direction Rw thereof. An insert pocket 42 cannot have more than two axially adjacent insert pockets 42. The tool pitch length LPT is constant (i.e. does not change) between each pair of axially adjacent insert pockets 42.

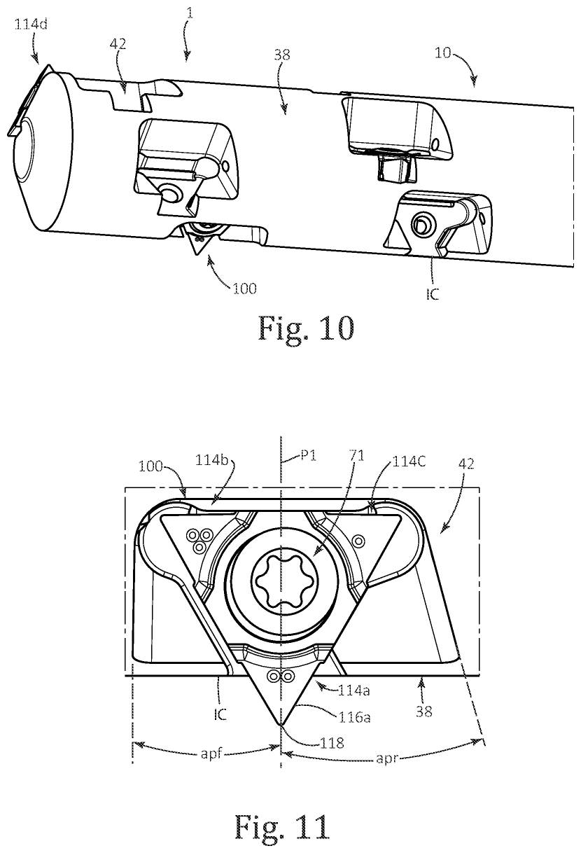

All thread-cutting inserts 100 may either completely axially overlap one another (i.e. have an axial spacing therebetween of zero) or be positioned at fixed intervals equaling to an insert pitch length LPI (as discussed below) relative to one another when secured to the plurality of insert pockets 42. An alternative definition, as shown in FIG. 9, may be that the number N of insert pockets 42, each at different axial locations, which are unoccupied (i.e. without cutting inserts seated therein) between each pair of axially adjacent occupied insert pockets 42 (i.e. with thread-cutting inserts 100 secured thereto), with an axial distance therebetween greater than zero, is constant. That is to say, the thread-cutting inserts 100 may be secured to only a subset of the plurality of insert pockets 42 and not all of the insert pockets 42. For example, in FIG. 1 the number N of unoccupied insert pockets 42 is N=0, in FIG. 9 the number N of unoccupied insert pockets 42 is N=1, and in FIG. 10, the number N of unoccupied insert pockets 42 is N=2.

It should be understood that in the present shown embodiments all of the axially adjacent insert pockets are located at a non-zero axial distance relative to one another. However some embodiments may have multiple insert pockets at the same axial location, yet these overlapping insert pockets are not functionally relevant to the insert pitch length LPI.

To create a single thread with a desired pitch length DPT (i.e. a desired thread pitch) it is important that the distance between cutting edges at differing axial locations (and consequently the cutting inserts) is constant and allows the machining of the desired pitch length DPT. In the thread milling cutter 1 it is necessary, for both tool rigidity and for machining differing thread pitches using the same tool, as will be discussed below, that at each axial location there is only one thread-cutting insert 100.

In some embodiments, there may be overlap between thread-cutting inserts 100 along the rotational axis S, as shown, for example, in FIG. 8, but the overlap is not an exact overlap—there must be a difference in the axial location of the protruding cutting edge 116a of each of the protruding cutting teeth 114a relative to the other protruding cutting edges 116a. That is to say, each pair of protruding cutting edges 116a are axially spaced apart from one another in a direction along the rotational axis S.

In some embodiments, each protruding cutting edge 116a is rotationally spaced apart from the other protruding cutting edges 116a in the rotation direction Rd. “Rotationally adjacent” is to be understood as the nearest in the rotation direction Rd. This allows gradual entry of the cutting edges into the workpiece during machining operations, thus lowering cutting forces.

In some embodiments, axially adjacent protruding cutting edges 116a are not rotationally adjacent to one another. That is to say, if a pair of protruding cutting edges 116a are nearest to one another in a direction along the rotational axis S, then there will be a different protruding cutting edge 116a which is closer to one (or both) of the pair of protruding cutting edges 116a in the rotation direction Rd than the other cutting edge of the pair of protruding cutting edges 116a. As specified above, such a configuration can result in axially non-consecutive working of the thread-cutting inserts 100 during machining operations, which may reduce the cutting forces at axial locations and improve surface quality.

An insert pitch length LPI is the distance between each pair of axially adjacent thread-cutting inserts 100, and is defined as the axial distance (i.e. measured parallel to the rotational axis S) between the protruding cutting edges 116a belonging to said each pair of axially adjacent thread-cutting inserts 100 with an axial distance therebetween greater than zero. Specifically, the insert pitch length LPI is measurable between two outermost edges 118 (i.e. nose), each belonging to one of a pair of axially adjacent thread-cutting inserts 100 with an axial distance therebetween greater than zero. The outermost edge 118 of each protruding cutting tooth 114a is the portion of the protruding cutting edge 116a located farthest in the outward radial direction Ro relative to the rest of the protruding cutting edges 116a.

In some embodiments, the outermost edge 118 of the protruding cutting tooth 114a may be considered as the portion of the protruding cutting edge 116a farthest from a center of mass of the thread-cutting insert 100 in the protruding cutting tooth 114a. When referring to a location of the thread-cutting insert 100 or the protruding cutting tooth 114a it may be understood to, more specifically, be referring to the outermost edges 118.

When all of the plurality of insert pockets 42 are occupied, meaning thread-cutting inserts 100 are releasably secured to all insert pockets 42, the number N is N=0 and the insert pitch length LPI is equal to the tool pitch length LPT. The insert pitch length LPI has a value equal to whole multiples of the tool pitch length LPT (i.e. a positive integer multiplied by the tool pitch length LPT).

The insert pitch length LPI and the tool pitch length LPT may fulfil the following condition: LPI=K*LPT=(1+N)*LPT, where K is an integer greater than zero and N=K−1 is the number of unoccupied insert pockets 42 located between each pair of axially adjacent thread-cutting inserts 100 (with an axial distance therebetween greater than zero) releasably secured to insert pockets 42. The insert pitch length LPI can be chosen according to the tool pitch length LPT and the aforementioned number N of unoccupied insert pockets 42. The tool pitch length LPT is dependent on the geometry of the thread milling tool 10 and is not adjustable via occupied/unoccupied insert pockets 42 of thread-cutting inserts 100.

In some embodiments, the protruding cutting edges 116a are evenly distributed about the imaginary helix H. The protruding cutting edges 116a being evenly distributed about the imaginary helix H means that each pair of axially adjacent protruding cutting edges 116a is located about the imaginary helix H at the same axial, and rotational, distance as other pairs of axially adjacent cutting edges 116a. This maintains the axial distance between the protruding cutting edges 116a, which is necessary for machining threads, while also evenly distributing the protruding cutting edges 116a about the rotational axis S.

In some embodiments, best shown in FIG. 16, a pocket distribution angle adp, defined as the angle in which the insert pockets 42 are displaced from one another in the rotation direction Rd relative to the rotational axis S, may fulfil the following condition: adp=360°/SP.

To clarify how one may have a greater variety of thread pitches using a single thread milling cutter 1 as described above, a non-limiting example will be given, assuming that the tool pitch length LPT and the pocket sum SP fulfil the conditions: LPT=7 mm, SP=9. In such case, when all the insert pockets 42 are occupied, the insert pitch length LPI is: LPI=7 mm, and the desired pitch lengths DPT which are thread pitches that can be machined are (in millimeters): DPT={0.25, 0.35, 0.5, 0.7, 1, 1.75, 3.5}. The above list of possible thread pitches are pitches which are common/desirable (i.e. a desired pitch length DPT) and which are also the result of dividing the insert pitch length LPI by an integer K1 (i.e. DPT=LPI/K1). Specifically, the above possible thread pitches are the result of dividing the insert pitch length LPI by the following integers, respectively: K1={28, 20, 14, 10, 7, 4, 2}.

Each thread-cutting insert machines a separate potion of the thread being machined. By the end of the machining operation, all of the portions of thread merge into one another, creating one whole, continuous, thread.

Similarly, if only one insert pocket 42 is occupied (meaning that the number N is smaller than the number of total insert pockets 42 in the thread milling tool 10 by one), then the insert pitch length LPI is undefined, and there are no limitations on the desired pitch lengths DPT which can be machined. However, using a greater number of thread-cutting inserts 100 is more effective and is thus desirable.

But when using multiple thread-cutting inserts 100 with an axial distance therebetween greater than zero, the insert pitch length LPI is finite, and thus there are restrictions on the desired pitch lengths DPT. However, when following the order of leaving at least one insert pocket 42 occupied, at least one axially adjacent insert pocket 42 with an axial distance therebetween greater than zero unoccupied and so on (i.e. the number N of unoccupied insert pockets is: N=1 and K=2), the insert pitch length LPI is twice the tool pitch length LPT (LPI=2*LPT), meaning: LPI=14 mm. In such case, the following desired pitch lengths DPT can be machined (in mm): DPT={0.25, 0.35, 0.5, 0.7, 1, 1.75, 2, 3.5}, and the number of thread-cutting inserts 100 which work during machining are 5.

Similarly, if out of every three insert pockets 42, with an axial distance between each pair of the three greater than zero, only one were to be occupied, with the other two being unoccupied (i.e. the number N of unoccupied insert pockets is: N=2 and K=3), then the insert pitch length LPI is now thrice the tool pitch length LPT (i.e. LPI=3*LPT and so LPI=21 mm). Now multiple additional (compared to N=0, N=1) desired pitch lengths DPT are possible: (in mm)—DPT={0.3, 0.6, 0.75, 1.5 and 3}, however the previously possible thread pitch—2 mm—can no longer be machined. The minimal number of thread-cutting inserts 100 with an axial distance therebetween greater than zero and which work during machining in this case is 3.

Continuing as such, the larger the pocket sum SP, the more variability possible in machining threads having differing thread pitches. It will be noted that the length of the hole to be machined (in case of blind holes), its diameter and other conditions may limit the pocket sum SP which determines the minimal longitudinal extent of the cutting portion 34. For example, the greater the longitudinal extent of the cutting portion 34 (with a constant diameter), the less rigid the thread milling cutter 1 will be. Thus, as mentioned above, it is preferable but optional to limit the number of insert pockets 42 to no more than SP=17.

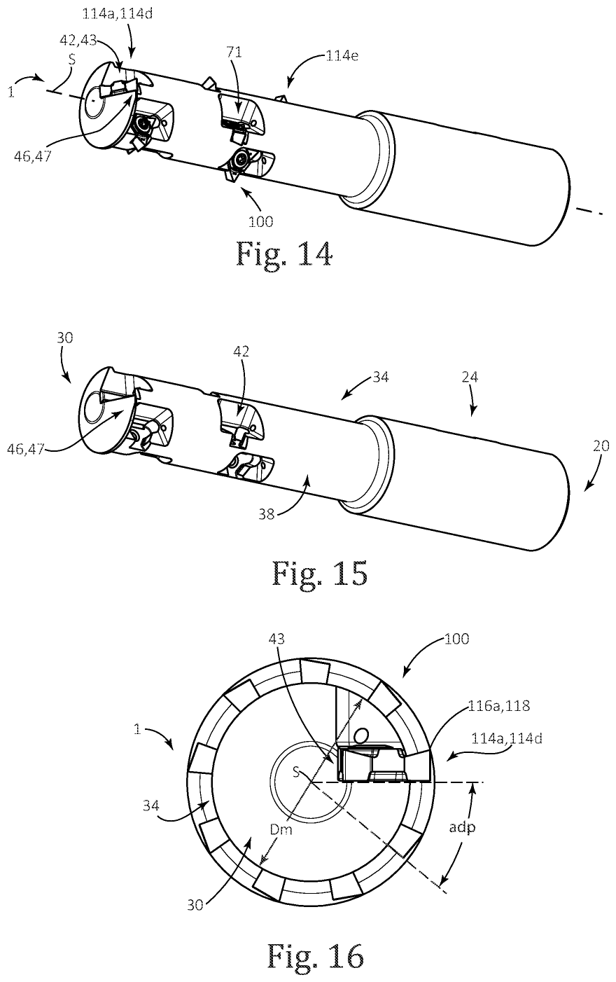

In thread milling cutters, it may be advantageous to provide support directly to protruding cutting teeth 114a. Thus in some embodiments, as shown in FIGS. 14 and 15, the cutting portion 34 may further include at least one support protrusion 46 extends beyond the imaginary cylinder IC coinciding with the cutting peripheral surface 38. This may then reinforce the protruding cutting teeth 114a, lowering chatter and allowing for better surface finish.

However, as discussed above, to be able to machine threads with different thread pitches it is advantageous to leave a plurality of the insert pockets 42 unoccupied, as discussed above. Having an insert pocket 42 unoccupied means any support protrusion 46 at the same axial location (i.e. located on the same plane perpendicular to the rotational axis S) would extend beyond the imaginary cylinder IC coinciding with the cutting peripheral surface 38 and impede cutting operations at that axial location.

So, to reiterate, to maintain the advantage of selective insert placement, which results in a variability in thread pitches not traditionally attainable using a single thread milling tool, at least one of the insert pockets 42 must be devoid of an associated support protrusion 46 (i.e. a support protrusion 46 which would support the thread-cutting insert 100 fastened to the insert pocket 42). A support protrusion 46 associated with one of the insert pockets 42 would be located at the same axial location as the insert pocket 42. In cases where the thread milling tool 10 includes the support protrusion 46 at the axial location of each of the insert pockets 42, leaving any of the insert pockets 42 unoccupied will likely result in the support protrusion 46 crashing into the workpiece being machined, thus having at least one insert pocket 42 devoid of an associated support protrusion 46 is necessary.

Differently worded, when the plurality of thread-cutting inserts 100 are releasably secured to all insert pockets 42, at least one of the protruding cutting teeth 114a is devoid of an associated support protrusion 46. To elaborate, in the shown embodiments, where the cutting peripheral surface 38 is cylindrical, this means that the at least one protruding tooth 114a extends beyond the imaginary cylinder IC coinciding with the cutting peripheral surface 38, as explained above, while the thread milling tool 10 does not extend beyond the imaginary cylinder IC, at the same axial location. For example, looking at FIG. 11, the thread milling tool 10 is circumscribed by the imaginary cylinder IC coinciding with the cutting peripheral surface 38 while the protruding cutting tooth 114a extends beyond the cutting peripheral surface 38 and the imaginary cylinder IC. In such a case, the insert pocket peripheral edge 44 of at least one of the insert pockets 42 (namely, the at least one insert pocket 42 devoid of an associated support protrusion 46) is the farthest portion of the thread milling tool 10 in the outward radial direction Ro at that axial location. As explained above, this allows an insert pocket 42 to remain unoccupied without the thread milling tool 10 coming in contact with a workpiece being machined.

In some embodiments, a majority of the insert pockets 42 are devoid of an associated support protrusion 46. Preferably, all insert pockets 42 may be devoid of an associated support protrusion 46. In such case the cutting portion 34 of the thread milling tool 10 is circumscribed by the imaginary cylinder IC coinciding with the cutting peripheral surface 38 at all axial locations.

In some embodiments, the protruding cutting teeth 114a of the all thread-cutting inserts 100 releasably secured to the thread milling tool 10, excluding at least one of a forwardmost cutting tooth 114d and a rearwardmost tooth 114e, are devoid of an associated support protrusion 46. The forwardmost cutting tooth 114d is defined as the protruding cutting tooth 114a of the thread-cutting insert 100 located farther in the forward direction Fw relative to the other thread-cutting inserts 100. Likewise, the rearwardmost cutting tooth 114e is defined as the protruding cutting tooth 114a of the thread-cutting insert 100 located farther in the rearward direction Rw relative to the thread-cutting inserts 100. In some embodiments, there may be a plurality of forwardmost cutting teeth 114d and a plurality of rearwardmost cutting teeth 114e.

When choosing which insert pockets 42 are to be occupied and which are to be unoccupied, the insert pocket 42 located at the extremity of the direction to be machined (i.e. the insert pocket 42 securing one of the forwardmost and rearwardmost cutting tooth 114d, 114e) will most times be occupied. It would then be advantageous to provide the support protrusion 46 at the same axial location of insert pockets 42 which will remain occupied in all desirable insert placements.

It will be noted that while one (or both) of the forwardmost and rearwardmost cutting teeth 114d, 114e may have its respective support protrusion 46, there may be other situations where it may be deemed advantageous to have support protrusions 46 at axial locations of other insert pockets 42. For example, every 2^{nd}, 3^{rd}, 4^{th} (and so on) insert pocket 42, each at a different axial location and numbered in order along either the forward direction Fw or the rearward direction Rw, may have a respective support protrusion 46 located at the same axial location. Differently said, the protruding cutting teeth 114a of each thread-cutting insert 100 secured to the insert pockets 42, excluding the protruding cutting teeth 114a secured in every 2^{nd}, 3^{rd} or 4^{th} insert pocket 42 each at a different axial location, may have an associated support protrusion 46.

In some embodiments, the forward end portion 30 of the thread milling tool 10 includes a forward insert pocket 43 recessed therein. The forward insert pocket 43 may include the same elements as other insert pockets 42. The forward insert pocket 43 may open out in the forward direction Fw. Worded differently, the forward insert pocket 43 may be devoid of a front pocket surface 52.

The forward end portion 30 may further include a forward support protrusion 47, at the same axial location as the forward insert pocket 43, extending beyond the imaginary cylinder IC coinciding with the cutting peripheral surface 38. In other words, the forward support protrusion 47 extends farther in the outward radial direction Ro than the insert pocket peripheral edge 44 of the forward insert pocket 43.

In some cases, it may be desired that the insert pocket 42 located most in the forward direction Fw (i.e. the forward insert pocket 43) will always be occupied during machining operations, thus it would be beneficial to supply the aforementioned support protrusion 46 at the same axial location. Because said insert pocket 42 will always be occupied, having a support protrusion 46 respective thereto will not hamper cutting operations.

In some embodiments, the thread-cutting inserts 100 are triangular and the peripheral insert surface 112 of each of the thread-cutting inserts 100 includes exactly three insert side surfaces, namely first, second and third insert side surfaces 113a, 113b, 113c. The third insert side surface 113c is located between the first and second insert side surfaces 113a, 113b. Preferably but optionally the second insert side surface 113b extends to the first insert side surface 113a and the third insert side surface 113c extends from the first insert side surface 113a to the second insert side surface 113b.

The first, second and third insert side surfaces 113a, 113b, 113c of each thread-cutting insert 100 may include, respectively, first, second and third depressions 120, 126, 132 recessed therein. The first, second and third depressions 120, 126, 132 are recessed in an intersection between the bottom insert surface 108 and, respectively, the first, second and third insert side surfaces 113a, 113b, 113c.

The first, second and third depressions 120, 126, 132 are delimited, respectively, by first second and third top depression surfaces 121, 127, 133, first, second and third back depression surfaces 122, 128, 134 and a first, second and third pair of opposing side depression surfaces 124a, 124b, 130a, 130b, 136a, 136b.

The first, second and third top depression surfaces 121, 127, 133 are the surfaces located nearest to the top insert surface 104. The first, second and third back depression surfaces 122, 128, 134 are the surfaces located farthest from the surface into which the first, second and third depressions 120, 126, 132 are recessed. To elaborate, the first back depression surface 122 is the surface located farthest from the first insert side surface 113a, the second back depression surface 128 is the surface located farthest from the second insert side surface 113b and the third back depression surface 134 is the surface located farthest from the third insert side surface 113c.

The first, second and third pair of opposing side depression surfaces 124a, 124b, 128a, 128b, 136a, 136b are the surfaces closest to one of the first, second and third insert side surfaces 113a, 113b, 113c, excluding the surface into which the respective depression of the first, second and third depressions 120, 126, 132 are recessed.

To elaborate, one surface of the first pair of opposing side depression surfaces 124a, 124b is the surface nearest to the second insert side surface 113b and the other surface of the first pair of opposing side depression surfaces 124a, 124b is the surface nearest to the third insert side surface 113c. Likewise, one surface of the second pair of opposing side depression surfaces 130a, 130b is the surface nearest to the first insert side surface 113a and the other surface of the second pair of opposing side depression surfaces 130a, 130b is the surface nearest to the third insert side surface 113c. Similarly, one surface of the third pair of opposing side depression surfaces 136a, 136b is the surface nearest to the first insert side surface 113a and the other surface of the third pair of opposing side depression surfaces 136a, 136b is the surface nearest to the second insert side surface 113b.

Each of the first, second and third depressions 120, 126, 132 may have the following dimensions: a depression length Ld1, a depression height Ld2 and a depression width Ld3. Each of the first, second and third depressions 120, 126, 132 are of the same size (i.e. each of Ld1, Ld2, Ld3 are constant for all three depressions), and are centered, respectively, about the first, second and third insert side surfaces 113a, 113b, 113c.

The first, second and third depressions 120, 126, 132 open out to the bottom insert surface 108 and the respective one of the first, second and third insert side surfaces 113a, 113b, 113c. It will be noted that saying the first, second and third depressions 120, 126, 132 are “centered about” the first, second and third insert side surfaces 113a, 113b, 113c, means they are similarly distanced from the other two of the first, second and third insert side surfaces 113a, 113b, 113c but are not similarly distanced from the top and bottom insert surfaces 104, 108. Rather, each of the depressions opens to the bottom insert surface 108 but does not open to the top insert surface 104. This is done to maintain the rigidity and stability of the thread-cutting inserts 100 as much as possible.

The depression length Ld1 of each of the first, second and third depressions 120, 126, 132 is defined as parallel to a second intersection I2 of the bottom insert surface 108 and the respective surface of the first, second and third insert side surfaces 113a, 113b, 113c. The depression length Ld1 of each of the first, second and third depressions 120, 126, 132 is measurable from one of the surfaces of the respective first, second and third pairs of opposing side depression surfaces 124a, 130a, 136a to the other surface of the same pair of the first, second and third pairs of opposing side depression surfaces 124b, 130b, 136b. The depression length Ld1 may fulfil the following condition: 3 mm≤Ld1≤10 mm. Preferably, the depression length Ld1 may fulfil the following condition: 3.5 mm≤Ld1≤9 mm.

The depression height Ld2 of each of the first, second and third depressions 120, 126, 132 is defined as perpendicular to the top and bottom insert surfaces 104, 108. The depression height Ld2 of each of the first, second and third depressions 120, 126, 132 is measurable from the bottom insert surface 108 to a respective one of the first, second and third top depression surfaces 121, 127, 133. The depression height Ld2 may fulfil the following condition: 0.8 mm≤Ld2≤1.2 mm.

The depression width Ld3 of each of the first, second and third depressions 120, 126, 132 is defined as perpendicular to both the depression length Ld1 and the depression height Ld2. The depression width Ld3 of each of the first, second and third depressions 120, 126, 132 is measurable from the respective one of the first, second and third insert side surfaces 113a, 113b, 113c to the respective one of the first, second and third back depression surfaces 122, 128, 134. The depression width Ld3 may fulfil the following condition: 0.6 mm≤Ld3≤1.4 mm.

The dimensions of the first, second and third depressions 120, 126, 132 are selected to ensure no abutment between the reinforcement rib 80 and any of the first, second and third depressions 120, 126, 132 while enough surface area is left for a secure abutment between the thread-cutting inserts 100 and the insert pockets 42. The above mentioned abutment refers to the abutment of the bottom insert surface 108 with the insert seat floor 68, as well as the abutment of the first insert side surface 113a with the rearward insert seat surface 72.

The insert side length LSI is defined as the distance, parallel to one of the first, second and third insert side surfaces 113a, 113b, 113c, from one outermost edge 118 of one of the first, second and third cutting teeth 114a, 114b, 114c to another outermost edge 118, as shown in FIG. 7c. The insert height LHI is defined as perpendicular to the top and bottom insert surfaces 104, 108, measurable from the bottom insert surface 108 to the top insert surface 104, as shown in FIG. 7c.

In embodiments where the thread-cutting inserts 100 have the shape of an equilateral triangle with the insert side length LSI and the insert height LHI of the thread-cutting inserts 100 fulfil the following conditions: 10 mm≤LSI≤12 mm and 2 mm≤LHI≤4 mm, the dimensions of the first, second and third depressions 120, 126, 132 may fulfil the following conditions: 3.5 mm≤Ld1≤5.5 mm, 0.8 mm≤Ld2≤1 mm and 0.6 mm≤Ld3≤0.8 mm. Preferably, the insert side length LSI and the insert height LHI may fulfil the following conditions: 10.5 mm≤LSI≤11.5 mm and 2.7 mm≤LHI≤3.5 mm.

Similarly, in embodiments where the thread-cutting inserts 100 have the shape of an equilateral triangle with the insert side length LSI and the insert height LHI fulfil the following conditions: 15 mm≤LSI≤17 mm and 2.5 mm≤LHI≤4.5 mm, the dimensions of the first, second and third depressions 120, 126, 132 may fulfil the following conditions: 6 mm≤Ld1≤9 mm, 0.9 mm≤Ld2≤1.1 mm and 0.9 mm≤Ld3≤1.2 mm.

Attention is now drawn to a method of machining a thread having a particular one of a predetermined number of different thread pitches using a single thread milling cutter 1. To elaborate, the method teaches how to be able to machine threads with thread pitches which one would conventionally be unable to machine using the same thread milling tool 10. Such difficulties arise from the need for the distance between each pair of axially adjacent protruding cutting edges 116a (i.e. the insert pitch length LPI) to be divisible into an integer by the desired pitch length DPT. In practice, an operator skilled in the art of thread cutting typically selects one from among a predetermined set of different thread pitches to cut in a workpiece. The desired pitch length DPT is the length of the pitch of the thread to be machined.

The method including the following steps:
a. supplying a thread milling tool;
b. selecting a desired pitch length DPT of the thread to be machined;
c. determining a smallest non-zero integer K (i.e. a whole number) such that K*LPT/DPT results in an integer;
d. placing thread-cutting inserts 100 in insert pockets 42 so that the following condition: LPI=K*LPT is achieved between axially adjacent thread-cutting inserts 100 placed in the thread milling tool 10 with an axial distance therebetween greater than zero; and
e. machining a workpiece in a, for example, helical interpolation, movement at the desired pitch length DPT of the thread being machined.

To elaborate, the smallest insert pitch length LPI possible for the desired pitch length DPT is identified by finding the lowest integer K such that the insert pitch length LPI divided by the desired pitch length DPT results in an integer. One way of finding said insert pitch length LPI is by multiplying the tool pitch length LPT by the integer K, starting from K=1 consecutively to K=SP−1. Continue thus until the desired condition (i.e. that K*LPT/DPT results in an integer) is met. The resulting integer K is then fed into the equation “LPI=K*LPT” to find the appropriate insert pitch length LPI.

Upon placing the thread-cutting inserts 100 in some (i.e. not all) of the insert pockets 42, the distance between the axially adjacent thread-cutting inserts 100 which are located at different axial locations is maintained as the insert pitch length LPI found in the previous paragraph.

Machine a workpiece in, for example, helical interpolation movements moving about the rotational axis S at a helical angle equal to the helical angle of the desired thread. This will result in thread-cutting inserts 100 secured to the thread milling tool 10 at differing axial locations each machining a separate thread segment which then joins into one continuous thread at the end of the machining process. Differently worded, protruding cutting tooth 114a secured to the thread milling tool 10 at different axial locations each machines a portion of a thread, with all portions merging into one continuous thread at the end of the machining operation.

It will be noted that when the number K is equal to, or greater than, the pocket sum SP of the thread milling tool used, then machining the desired pitch length DPT using said tool is not possible. This does not include the usage of only one thread-cutting insert 100, which as mentioned above allows to machine any pitch length.

Another method of machining different thread pitches using the same thread milling cutter 1 is as follows: the thread-cutting insert 100 are secured to only a subset of the plurality of insert pockets 42 and not all of the insert pockets 42. That is to say, upon releasably securing thread-cutting inserts 100 to the insert pockets 42 of the thread milling tool 10, at least one of the insert pockets 42 of the thread milling cutter 1 is to be left unoccupied during machining operations.

In this manner, the distance between the protruding cutting edges 116a is changed, allowing more thread pitches by which the insert pitch length LPI is divisible into integers, as discussed above. This is possible due to some (if not all) of the protruding cutting edges 116a being devoid of support in a direction parallel to the rotation direction Rd (i.e. have no support protrusion 46 at their axial location).

Further, in some preferred, but optional, embodiments, the above method further includes having the number N of unoccupied insert pockets 42 at different axial locations which are located between each axially adjacent pair of thread-cutting inserts 100, which are located at different axial locations, be the same. Differently worded, each axially adjacent pair of occupied insert pockets 42 with an axial distance therebetween greater than zero is separated by an identical number N of unoccupied insert pockets 42 with an axial distance therebetween greater than zero. It will be noted that said number N of unoccupied insert pockets 42 is greater than zero as specified above (i.e. N>0).

In some embodiments, a thread milling cutter 1 has a thread milling tool 10, as described above, and a plurality of thread-cutting inserts 100 releasably secured thereto. Each thread-cutting insert 100 has opposing top and bottom insert surfaces 104, 108. Each thread-cutting insert 100 also has a peripheral insert surface 112 connecting the top and bottom insert surfaces 104, 108 and a protruding cutting tooth 114a formed with a protruding cutting edge 116a located at an intersection of the top insert surface 104 and the peripheral insert surface 112. The protruding cutting tooth 114a protrudes in the outward radial direction Ro from the respective insert pocket 42. Each insert pocket 42 of the thread milling tool 10 has an insert seat center 70. All axially adjacent insert pockets 42 are axially spaced apart from one another by a tool pitch length LPT measured parallel to the rotational axis S, from the insert seat center 70 of one of said insert pockets 42 to an axially adjacent one of said insert pockets 42. Each pair of axially adjacent thread-cutting inserts 100 are distanced by an insert pitch length LPI defined as the axial distance along the rotational axis S, between the protruding cutting edges 116a belonging to said each pair of axially adjacent thread-cutting inserts 100. The insert pitch length fulfils the following condition: LPI=K*LPT, where K is an integer greater than 1. In the axial direction along the rotational axis S, a number N=K−1 of insert pockets 42 remains unoccupied between said each pair of axially adjacent thread-cutting inserts 100.

Although the subject matter of the present application has been described to a certain degree of particularity, it should be understood that various alterations and modifications could be made without departing from the spirit or scope of the invention as hereinafter claimed.

What is claimed is:

1. A thread milling tool (10) being rotatable in a rotation direction (Rd) about a rotational axis (S) defining opposing inward and outward radial directions (Ri, Ro) and opposing forward and rearward directions (Fw, Rw), the thread milling tool (10) comprising:
a shank portion (24); and
a cutting portion (34) located forwardly of the shank portion (24), the cutting portion (34) comprising:
a cylindrical-shaped cutting peripheral surface (38); and
a plurality of insert pockets (42) recessed into the cutting peripheral surface (38);
wherein:
the plurality of insert pockets (42) are at least five insert pockets (42);
the thread milling tool (10) is an integrally formed tool; and
at least one insert pocket (42), which is not a forward insert pocket (43), is devoid of an associated support protrusion (46).

2. The thread milling tool (10) according to claim 1, wherein all of the insert pockets (42) are axially spaced apart from one another along the rotational axis (S).

3. The thread milling tool (10) according to claim 2, wherein a diameter Dm of the cutting portion (34) fulfills the following condition: Dm≤50 mm.

4. The thread milling tool (10) according to claim 2, wherein the plurality of insert pockets (42) are evenly distributed about and define an imaginary helix (H) centered about the rotational axis (S).

5. The thread milling tool (10) according to claim 4, wherein axially adjacent insert pockets (42) are not rotationally adjacent to one another and the imaginary helix (H) circles the rotational axis (S) at least twice.

6. The thread milling tool (10) according to claim 5, wherein a lap sum SL, defined as the number of times the imaginary helix (H) circles the rotational axis (S), and a pocket sum SP, defined as the number of insert pockets (42) of the thread milling tool (10), fulfil the following condition: SP/SL does not result in an integer.

7. The thread milling tool (10) according to claim 1, wherein a majority of the insert pockets (42) are devoid of an associated support protrusion (46).

8. The thread milling tool (10) according to claim 7, wherein only the forward insert pocket (43) has an associated support protrusion (46).

9. The thread milling tool (10) according to claim 1, wherein there are at most seventeen axially spaced apart insert pockets (42).

10. The thread milling tool (10) according to claim 1, wherein each pair of rotationally adjacent insert pockets (42) are, at least partially, rotationally spaced apart from one another in the rotation direction (Rd).

11. The thread milling tool (10) according to claim 1, wherein at least one insert pocket (42) is surrounded by the cutting peripheral surface (38).

12. The thread milling tool (10) according to claim 1, wherein each of the plurality of insert pockets (42) comprises:
opposing rear and front pocket surfaces (48, 52) with a back pocket surface (56) extending therebetween, the rear and front pocket surfaces (48, 52) being transverse to the rotational axis (S);
a bottom pocket surface (60) transverse to the rotation direction (Rd) and extending between the rear, front and back pocket surfaces (48, 52, 56); and
an internal front pocket angle apf, defined between the front pocket surface (52) and a first imaginary plane (P1) perpendicular to the rotational axis (s), and an internal rear pocket angle apr, defined between the rear pocket surface (48) and the first imaginary plane (P1), fulfil the following condition: apf<apr.

13. The thread milling tool (10) according to claim 1, wherein each of the plurality of insert pockets (42) comprises:
opposing rear and front pocket surfaces (48, 52) with a back pocket surface (56) extending therebetween, the rear and front pocket surfaces (48, 52) being transverse to the rotational axis (S);
a bottom pocket surface (60) transverse to the rotation direction (Rd) and extending between the rear, front and back pocket surfaces (48, 52, 56); and
an insert seat (64) recessed into the bottom pocket surface (60), the insert seat (64) comprising:
an insert seat floor (68) transverse to the rotation direction (Rd);
a rearward insert seat surface (72) transverse to the rotational axis (S);
a forward insert seat surface (76) located forwardly of the rearward insert seat surface (72); and
a reinforcement rib (80) extending in the rotation direction (Rd) from the insert seat floor (68) to a top rib surface (82), extending in the forward direction (Fw) from the rearward insert seat surface (72) to a forward rib surface (84) and delimited in the outward radial direction (Ro) and a direction opposite thereto, respectively, by first and second rib side surfaces (86, 88).

14. The thread milling tool (10) according to claim 13, wherein:
a rib height Lr1, defined as perpendicular to the insert seat floor (68) and measurable from the insert seat floor (68) to the top rib surface (82), fulfils the following condition: 0.4 mm≤Lr1≤1 mm;
a rib width Lr2, defined as perpendicular to the rearward insert seat surface (72) and measurable from the rearward insert seat surface (72) to the forward rib surface (84), fulfils the following condition: 0.2 mm≤Lr2≤1 mm; and
a rib length Lr3, defined as parallel to a first intersection (Ir) of the rearward insert seat surface (72) with the insert seat floor (68) and measurable from the first rib side surface (86) to the second rib side surface (88), fulfils the following condition: 1 mm≤Lr3≤5 mm.

15. A thread milling cutter (1) comprising a thread milling tool (10) according to claim 1 and a plurality of thread-cutting inserts (100) releasably secured thereto, each thread-cutting insert (100) comprising:
opposing top and bottom insert surfaces (104, 108);
a peripheral insert surface (112) connecting the top and bottom insert surfaces (104, 108); and
a protruding cutting tooth (114a) formed with a protruding cutting edge (116a) located at an intersection of the top insert surface (104) and the peripheral insert surface (112), the protruding cutting tooth (114a) protruding in the outward radial direction (Ro) from the respective insert pocket (42);
each insert pocket (42) of the thread milling tool (10) has an insert seat center (70); and
all axially adjacent insert pockets (42) which are located at different axial locations are axially spaced apart from one another by a tool pitch length (LPT) measured parallel to the rotational axis (S), from the insert seat center (70) of one of said insert pockets (42) to an axially adjacent one of said insert pockets (42);
wherein:
all axially adjacent thread-cutting inserts (100) which are located at different axial locations are distanced by an insert pitch length (LPI), defined as the axial distance along the rotational axis (S) between the protruding cutting edges (116a) belonging to said each pair of axially adjacent thread-cutting inserts (100); and
at least one of the protruding cutting teeth (114a) is devoid of an associated support protrusion (46).

16. The thread milling cutter (1) according to claim 15, wherein each thread-cutting insert (100) comprises:
opposing top and bottom insert surfaces (104, 108), with a peripheral insert surface (112) extending therebetween, the peripheral insert surface (112) comprising:
a first insert side surface (113a);
a second insert side surface (113b); and
a third insert side surface (113c) located between the first and second insert side surfaces (113a, 113b);
wherein each of the plurality of insert pockets (42) comprises:
opposing rear and front pocket surfaces (48, 52) with a back pocket surface (56) extending therebetween, the rear and front pocket surfaces (48, 52) being transverse to the rotational axis (S);
a bottom pocket surface (60) transverse to the rotation direction (Rd) and extending between the rear, front and back pocket surfaces (48, 52, 56); and
an insert seat (64) recessed into the bottom pocket surface (60), the insert seat (64) comprising:
an insert seat floor (68) transverse to the rotation direction (Rd);
a rearward insert seat surface (72) transverse to the rotational axis (S);
a forward insert seat surface (76) located forwardly of the rearward insert seat surface (72); and
a reinforcement rib (80) extending in the rotation direction (Rd) from the insert seat floor (68) to a top rib surface (82), extending in the forward direction (Fw) from the rearward insert seat surface (72) to a forward rib surface (84) and delimited in the outward radial direction (Ro) and a direction opposite thereto, respectively, by first and second rib side surfaces (86, 88);
wherein:
first, second and third depressions (120, 126, 132) are recessed at the intersection between the bottom insert surface (108) and, respectively, the first, second and third insert side surfaces (113a, 113b, 113c);
the first, second and third depressions (120, 126, 132) are delimited, respectively, by first, second and third top depression surfaces (121, 127, 133), first, second and third back depression surfaces (122, 128, 134) and a first, second and third pair of opposing side depression surfaces (124a, 124b, 130a, 130b, 136a, 136b); and
each of the first, second and third depressions (120, 126, 132) has the following dimensions:
a depression length Ld1, parallel to a second intersection (I2) of the bottom insert surface (108) and the respective surface of the first, second and third insert side surfaces (113a, 113b, 113c) and measurable from one of the surfaces of one of the first, second and third pair of opposing side depression surfaces (124a, 130a, 136a) to the other surface of the same pair of the first, second and third pair of opposing side depression surfaces (124b, 130b, 136b), fulfilling the following condition: 3 mm≤Ld1≤10 mm;
a depression height Ld2, perpendicular to the top and bottom insert surfaces (104, 108) and measurable from the bottom insert surface (108) to the respective one of the first, second and third top depression surface (121, 127, 133), fulfilling the following condition: 0.8 mm≤Ld2≤1.2 mm; and
a depression width Ld3, perpendicular to both the depression length (Ld1) and the depression height (Ld2), and measured from one of the first, second and third insert side surfaces (113a, 113b, 113c) to the respective one of the first, second and third back depression surfaces (122, 128, 134), fulfilling the following condition: 0.6 mm≤Ld3≤1.4 mm.

17. The thread milling cutter (1) according to claim 15, wherein:
the thread-cutting inserts (100) are releasably secured to a subset of the insert pockets (42) such that at least some of the insert pockets (42), which are located at different axial locations, are unoccupied, with a number N of unoccupied insert pockets (42), which are located at different axial locations, being located between each axially adjacent pair of thread-cutting inserts (100), which are located at different axial locations, being the same.

18. A method of machining a thread having a particular one of a predetermined number of different thread pitches using a single thread milling cutter, the method comprising:
(a) providing a thread milling tool;
(b) selecting a desired pitch length DPT of the thread to be machined;
(c) determining a smallest non-zero integer K such that K*LPT/DPT results in an integer;
(d) placing thread-cutting inserts (100) in insert pockets (42) so that the following condition: LPI=K*LPT is achieved between axially adjacent thread-cutting inserts (100) placed in the thread milling tool (10); and
(e) machining a workpiece in a movement at the desired pitch length DPT of the thread being machined.

19. A method of machining different pitched threads using a thread milling cutter (1) having a rotational axis (S) and a plurality of insert pockets (42) arranged along an imaginary helix (H), wherein the thread-cutting inserts (42) are secured to only a subset of the plurality of insert pockets (42) and not all of the insert pockets (42).

20. The method according to claim 19, wherein there is a constant number N of unoccupied insert pockets (42), each at different axial locations, which are located between each axially adjacent pair of thread-cutting inserts (100), which are located at different axial locations.
